(19) United States
(12) Patent Application Publication
(10) Pub. No.: US 2009/0016482 A1
(43) Pub. Date: Jan. 15, 2009

(54) ARTIFACT SUPPRESSION

(75) Inventor: Gilad Shechter, Haifa (IL)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N. V., Eindhoven (NL)

(21) Appl. No.: 12/159,792

(22) PCT Filed: Dec. 29, 2006
(86) PCT No.: PCT/US07/60005

§ 371 Date: Jul. 1, 2008

Related U.S. Application Data
(60) Provisional application No. 60/766,255, filed on Jan. 5, 2006.

(51) Int. Cl. G01N 23/04

(52) U.S. Cl. 378/4

(57) ABSTRACT

A computed tomography scanner (10) includes a plurality of detector elements (100). The signals generated by the detector elements (100) may include an error component which can lead to artifacts in a reconstructed image. An apparatus includes a signal level detector (208) and a signal change detector (210) which evaluate the characteristics of a signal generated by a first detector element during the scan. The apparatus also includes a signal comparator (214) which evaluates a calibrated version of the signal generated by the first detector in relation to a signal generated by a second radiation sensitive detector element. Based on the results of the evaluations, a signal corrector (218) corrects temporal portions of the calibrated first detector signal which are suspected to lead to an artifact.

The present invention finds particular application to the suppression of artifacts in computed tomography (CT) imaging. It also finds application to situations in which it is desirable to identify and correct suspect detector signals.

CT scanners have proven to be invaluable in providing information indicative of the internal structure of an object. In medical imaging, for example, CT scanners are widely used to provide images and other information about the physiology of human patients. Typically, the information generated by a CT scan is presented by way of one or more human readable images. Of course, it is generally desirable that the images accurately reflect the structure of the scanned object and contain a minimum of artifacts. One factor which can lead to artifacts are variations in detector performance.

Recent years have seen the rapid adoption of multi-slice CT and a move to detectors having an ever increasing numbers of slices. This in turn has led to a need for larger and more complex detector arrays. It is generally desirable to simplify the manufacture and testing of these detector arrays, to reduce the need to discard detectors or detector elements, and to reduce detector design constraints. This is especially true in cases where suspect signals generated by an otherwise functional detector or detector element can be identified and dynamically corrected.

Aspects of the present invention address these matters, and others.

According to a first aspect of the invention, a method includes the steps of evaluating a signal generated by a first radiation sensitive detector during a computed tomography scan of an object and evaluating a calibrated version of the signal, where the calibrated version includes the results of a detector calibration. Based on the results of the evaluation of the signal and the evaluation of the calibrated version of the signal, a calibrated version of a signal generated by a second radiation sensitive detector during the computed tomography scan is used to generate a corrected calibrated first detector signal. The steps of evaluating a signal, evaluating a calibrated version of the signal, and generating a corrected version are repeated for each of a plurality of radiation sensitive detectors. The corrected detector signals are to generate volumetric data indicative of the object, and a human readable image is displayed.

According to another aspect of the invention, an apparatus includes first, second, and third detector elements which generate respective time varying first, second, and third detector signals indicative of radiation detected during a computed tomography scan of an object. The apparatus also includes a detector calibrator which receives the first, second and third detector signals and generates respective time varying calibrated first, second, and third detector signals, and a corrector which corrects temporal portions of the first detector signal. The temporal portions are identified based on a characteristic of the first detector signal and a characteristic of the calibrated first detector signal, and temporally corresponding portions of the second and third calibrated detector signals are used to correct the identified portion of the first detector signal.

According to another aspect of the present invention, a computer readable storage medium contains instructions which, when executed by a computer processor, cause the processor to carry out a method which includes the steps of evaluating a signal generated by a first radiation sensitive detector element in the course of a computed tomography scan of an object to determine whether the signal is suspected of containing an error resulting from a characteristic of the detector element, and evaluating a calibrated version of the signal generated by the first detector element in relation to a calibrated version of a temporally corresponding signal generated by a second radiation sensitive detector element in the course of the scan to determine whether the calibrated version of the signal generated by the first detector element is suspected of containing the error. If both the signal generated by the first detector element and the calibrated version of the signal generated by the first detector element are suspected of containing the error, the calibrated version of the signal generated by the second detector element is used to correct the calibrated version of the signal generated by the first detector element.

Those skilled in the art will appreciate still other aspects of the present invention upon reading an understanding the attached figures and description.

The present invention is illustrated by way of example and not limitation in the figures of the accompanying drawings, in which like references indicate similar elements and in which:

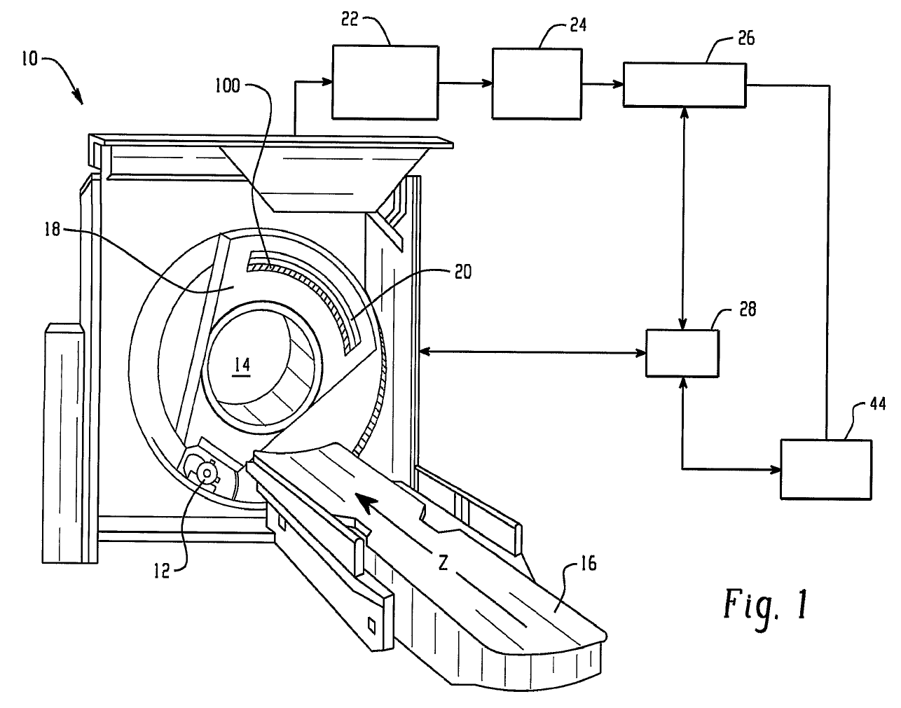

FIG. 1 depicts a CT scanner.

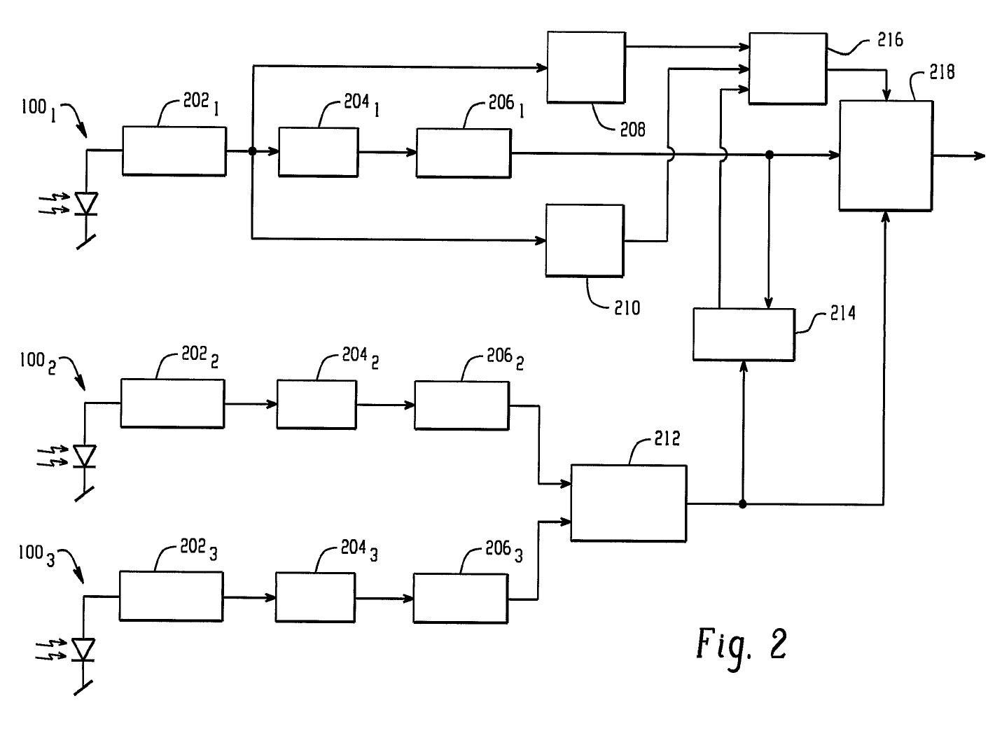

FIG. 2 depicts the signal chain for an exemplary CT detector element.

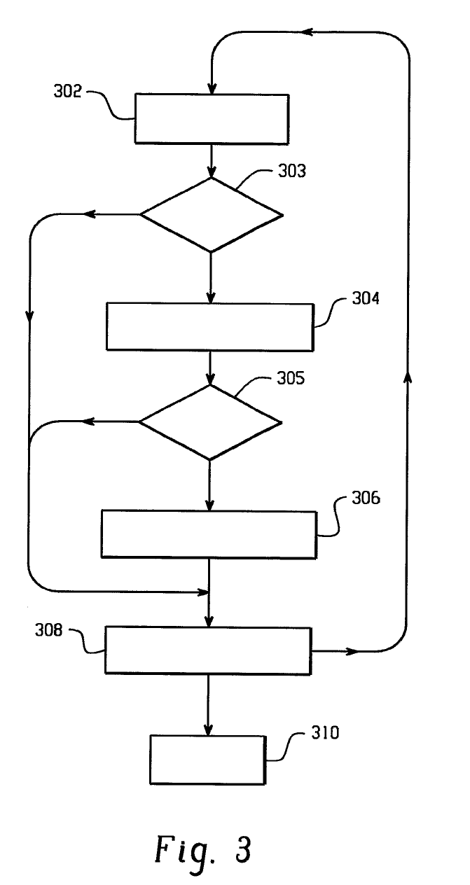

FIG. 3 depicts a sequence of steps performed in a detector signal correction.

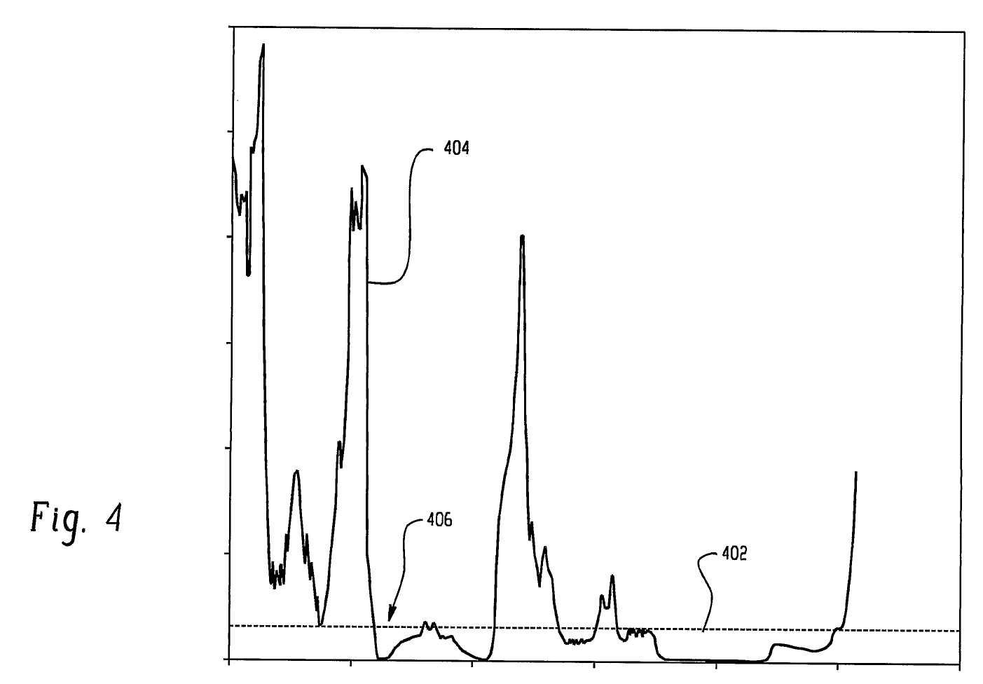

FIG. 4 depicts a raw detector signal generated by an exemplary CT detector element as a function of time.

With reference to FIG. 1, a CT scanner 10 includes a rotating gantry 18 which rotates about an examination region 14. The gantry 18 supports a radiation source 12 such as an x-ray tube. The gantry 18 also supports an x-ray sensitive detector 20 which subtends an arc on the opposite side of the examination region 14. X-rays produced by the x-ray source 12 traverse the examination region 14 and are detected by the detector 20. An object support 16 supports an object such as human patient in the examination region 14. The support 16 is preferably movable in coordination with the rotation of the gantry 18 so as to provide helical scanning.

The detector 20 includes an arcuate array of detector elements 100 arranged in a plurality of longitudinal rows or slices and transverse columns. In one implementation, the detector includes 64 or more slices. Each detector element 100 includes a scintillator in optical communication with a photodiode. The photodiodes are preferably fabricated from arrays of back illuminated photodiodes (BIPs), although other photodiode or photodetector technologies can be used. A so-called fourth generation scanner configuration, in which the detector 20 spans an arc of 360 degrees and remains stationary while the x-ray source 12 rotates, as well as flat panel detectors, may also be implemented. Detector having greater or lesser number of slices may likewise be implemented.

A data acquisition system 22 preferably located on the rotating gantry 18 receives signals originating from the various detector elements 100 and provides necessary signal conditioning, analog to digital conversion, multiplexing, and like functionality. The signal generated by each detector element 100 is acquired at each of a plurality of views or frames as the gantry 18 rotates about the examination region 14. Viewed from the perspective of a given detector element 100, the data acquisition system 26 can be viewed as providing a time varying signal indicative of the radiation detected by the detector element 100 as a function of time. Viewed from the perspective of a given view, the data acquisition system 22 can be viewed as providing signals indicative of the radiation detected by the various detector elements 100 during the time period covered by the view.

As will be described in greater detail below, an adaptive signal corrector 24 receives the signals generated by the data acquisition system 22 and corrects detector element 100 signals which are likely to cause artifacts in a reconstructed image. A reconstructor 26 reconstructs the corrected data to generate volumetric data indicative of the object under examination, for example the interior anatomy of a patient.

A general purpose computer serves an operator console 44. The console 44 includes a human-readable output device such as a monitor or display and an input device such as a keyboard and mouse. Software resident on the console allows the operator to control the operation of the scanner by establishing desired scan protocols, initiating and terminating scans, viewing and otherwise manipulating the volumetric image data, and otherwise interacting with the scanner.

A controller 28 coordinates the various scan parameters as necessary to carry out a desired scan protocol, including x-ray source 12 parameters, movement of the patient couch 16, and operation of the data acquisition system 26.

As noted above, the detector elements I 00 each include a photodiode. These photodiodes may contain impurities which trap hole charge carriers and release them over the course of a delay period which extends over many views or frames. As a result, the signal acquired in a given view includes both a direct (i.e., non-delayed) and an indirect (i.e., delayed) signal component.

In some situations, the delayed signal is manifested as an artificial increase in the detector element 100 output, and can lead to scratch or ring like artifacts in the reconstructed image. The artifact is typically not significant where the delayed signal component is relatively small, or where the condition exists for only a short period of time. However, the artifact becomes increasingly visible as the indirect signal component becomes a relatively larger component of the detector element 100 signal, and more so where the condition exists over an increasingly greater number of views. This situation is especially likely where the signal from a particular photodiode drops rapidly where, between successive views, the detected x-ray beam passes through a relatively more attenuative portion of the object over successive views. For a given ratio of indirect to direct signal, the artifact is also more noticeable for detector elements 100 which observe rays which pass relatively nearer to the isocenter. It is desirable to reduce the artifact resulting from the delayed signal.

FIG. 2 depicts a portion of the signal chain for an exemplary first detector element 100₁. Portions of the signal chain for exemplary second 100₂ and third 100₃ detector elements are shown for the purposes of illustrating the signal chain of the first detector element 100₁; it will be understood that the complete second 100₂ and third 100₃ detector element signal chains are analogous to those of the first detector element 100₁.

Signal conditioning circuitry 202₁ preferably implemented as part of the data acquisition 22 receives the signals generated by the detector element 100₁ in response to detected radiation and provides necessary amplification, noise filtering, analog to digital conversion, and like functionality to generate a raw detector signal.

The data provided by the signal conditioner 202₁ is processed by a logarithmic operator 204, which takes the logarithm of the detector signal. A detector calibrator 204₁ applies calibrations to the logged signal to generate a calibrated first detector signal. The detector calibrations typically correct for variations in gain and offset among the various detector elements 100. Other desired calibrations, such as beam hardening, temperature, and geometric calibrations, may also be applied. Some or all of the detector calibrations may also performed prior to the log operator 204₁.

As shown in FIG. 2, the signal chain for the second 100₂ and third 100₃ detector elements are analogous to that of the first detector element 100₁. While depicted separately for ease of explanation, it is generally desirable to multiplex some or all of the signal conditioning 202, log operator 204, and detector calibrator 206 functionality among multiple detector elements 100.

A signal level detector 208 determines whether the output signal generated by the first detector element 100₁ has a desired value over a desired time period (i.e., over a desired number of acquired views). A signal change detector 210 detects temporal changes in the first detector element 100₁ signal between successive views or frames.

A signal interpolator 212 interpolates calibrated second 100₂ and third 100₃ detector signals to generate an interpolated detector signal. The second 100₂ and third 100₃ detector elements are preferably neighbors of the first detector element 100₁, for example being located adjacent to the first detector element 100₁ and in the same row or column. In this regard, it should be noted that the interpolator 214 may also interpolate signals generated by different or still additional detector elements, for example additional first or higher order neighbors of the first detector element 100₁. Moreover, the interpolator 212 may be omitted, and the signal from a single detector element (e.g. 100₂) may be used.

A signal comparator 214 compares the calibrated first detector signal and the interpolated detector signal. More specifically, the comparator compares the values of the respective signals over a desired tine period (i.e., over a plurality of acquired views).

A logical and operator 216 receives the time dependent outputs of the signal level detector 208, signal change detector 210, and the signal comparator 214 and generates a logical true output signal during time periods (i.e. views) during which its input conditions are satisfied.

A corrector 218 receives the calibrated first detector signal, the interpolated detector signal, and the output of the and operator 216. If the output of the and operator 216 is true, the corrector 218 replaces the calibrated first detector signal with the interpolated signal to generate a corrected calibrated first detector signal. If the output of the and operator 216 is false, no correction is performed, and the corrected calibrated first detector signal is equal to the calibrated first detector signal.

In one embodiment, the log operator 204, detector calibrator 206, signal level detector 208, signal change detector 210, signal interpolator 212, signal comparator 214 logical and operator 216, and corrector 218 are implemented via computer software carried by suitable computer readable media and executed by a computer processor (or processors) associated with the reconstructor 26. Some or all of the functions may also be implemented using a separate computers or computer processor(s), in hardware, or the like.

In any case, the signal corrector 24 preferably generates corrected output signals for each of the detector elements 100 in the detector 20 in a manner analogous to that described above for the exemplary first detector 100₁. Note that detector elements 100 located at an edge or corner of the detector 20 may not have two neighbors in a given row or column. In such case, it may be desirable to forego correction of these detector elements or to provide a corrected signal based on the value of a single neighbor.

The corrected detector signals ale used by the reconstructor 26 to generate volumetric data indicative of the object.

In operation, the data acquisition system 22 provides signals indicative of the radiation detected by each of the detector elements 100 at each of a plurality of views. As human patients and most objects under examination have non-uniform radiation attenuation characteristics, the signal generated by each detector element 100 can be expected to vary from view to view (i.e., as a function of time). With particular reference to FIGS. 2, 3 and 4, the signal correction will again be described in connection with the exemplary first detector element 100₁, it being understood that an analogous correction is performed on the signals provided by the various detector elements 100.

At 302, the raw first detector signal is evaluated to identify whether the signal is suspected of leading to an artifact. As illustrated in FIG. 2, the signal level detector 208 evaluates whether the amplitude of the raw signal is less than a threshold value 402, as occurs when radiation received by the detector element has traversed a relatively higher attenuation path. The signal level detector 208 preferably also determines whether the condition persists for a time period sufficient to lead to a significant artifact. The signal change detector 210 evaluates whether the raw signal has experienced a significant drop over a relatively short time period, as occurs when the x-ray beam as observed by the detector element passes through relatively less attenuative portion of the object before traversing the higher attenuation path. If both of these situations are satisfied, the delayed signal component is suspected of being a relatively large percentage of the direct component and therefore to lead to an artifact, and the signal is identified as suspect at 303. Such a situation is depicted by the drop in detector signal depicted at region 404. The suspected temporal portion of the signal comes right after this drop as depicted at 406. If the conditions are not satisfied, the signal is not identified as suspect.

If the raw first detector signal was identified as suspect, the temporally corresponding calibrated first detector signal is evaluated at 304 to further determine whether the signal from the first detector element is suspected of leading to an artifact. This may be accomplished by comparing the calibrated first detector signal to a temporally corresponding signal generated by one or more neighboring detector elements. As illustrated in FIG. 2, the signal comparator 214 compares the calibrated first detector signal to a signal resulting from the interpolation of the calibrated signal generated by two more neighbors. A calibrated first detector signal which is lower than those of its neighbors would ordinarily indicate that the first detector element has detected radiation which has traversed a relatively less radiation attenuative path. However, when coupled with the fact that the raw first detector signal was considered suspect, the results of this comparison tend to confirm that the first detector signal contains a significant delayed component and is thus likely to lead to an artifact. The calibrated signals are preferably compared over a desired time period (i.e., over a desired number of views) to determine whether the condition persists over the time period. This tends to further confirm that the relatively lower calibrated signal results from a delayed signal component. Moreover, the resultant artifact tends to become noticeable in the reconstructed image only where the condition persists over a number of views. Such a situation is depicted at region 406 in FIG. 4. If these conditions are satisfied, the first detector element signal is confirmed as suspect at 305. If not, the detector signal is not corrected. Note also that step 304 may be performed prior to step 302.

The calibrated first detector signal is corrected at 306. As illustrated in FIG. 2, the corrector 218 replaces the calibrated first detector signal with the temporally corresponding interpolated signal. The replacement is preferably performed for each of the views which correspond to the temporal region identified as 406 in FIG. 4. Using the signal level detector, the signal change detector, and the calibrated signal comparator, the correction of detector signal portions suspected of having an artificial increase caused by the hole trapping phenomenon may be performed based only on the information acquired during the scan, and does not require any particular pre-scan calibration other than the detector calibrations which are ordinarily performed.

At 308, the process is repeated for each of a plurality of detector elements. At 310, the reconstructor 26 uses the resultant corrected signals to generate volumetric image data indicative of the object for display on the operator console 44 or otherwise.

The effects of the hole trapping phenomenon and the significance of the resultant artifact can be determined empirically for a particular detector 20 and scanner 10 configuration. The maximum expected amplitude and delay period of the indirect signal can be characterized globally for all the detector elements 100 as a result of testing or simulation of a particular photodiode type. The percentage or ratio of the indirect to direct signal and the estimated time period which leads to a visible artifact for a detector element 100 located a given location on the detector 20 can also be estimated.

For example, a particular photodiode type may be found to present a maximum delayed signal of about 0.4 nanoamperes (nA) over a delay period of about 100 milliseconds (mS). For a detector element which observes rays which pass approximately 100 millimeters (mm) from the isocenter, artifacts may also become noticeable when the delayed signal becomes greater than about five percent (5%) of the direct signal. Merging these facts, most artifacts would be expected to appear only when the photodiode signal drops below about 7 nA. Based on a review of the reconstructed images, the resultant artifact becomes significant where the situation persists for a time period greater than about the gantry rotation time divided by 10. The parameters used by the signal level detector 208, signal change detector 210, and signal interpolator 212 may be established accordingly. As the effects of the delayed signal are relatively more significant for detector elements 100 which detect radiation passing nearer the isocenter, the various parameters may have different values based on the position of a particular detector element 100 in the detector 20. It may also desirable to adjust one or more of parameters dynamically, for example by shortening the required time period in cases where the calibrated first detected signal deviates significantly from the interpolated signal.

It should also be noted that the techniques described above are not limited to suppressing artifacts resulting from the hole trapping phenomenon. Accordingly, the techniques may be applied more generally to situations in which it is desired to correct suspect detector signals.

Of course, modifications and alterations will occur to others upon reading and understanding the preceding description. It is intended that the invention be construed as including all such modifications and alterations insofar as they come within the scope of the appended claims or the equivalents thereof.

1. A method comprising:
evaluating a signal generated by a first radiation sensitive detector during a computed tomography scan of an object;
evaluating a calibrated version of the signal, the calibrated version including the results of a detector calibration;
based on the results of the evaluation of the signal and the evaluation of the calibrated version of the signal, using a calibrated version of a signal generated by a second radiation sensitive detector during the computed tomography scan to generate a corrected calibrated first detector signal;
repeating the steps of evaluating a signal, evaluating a calibrated version of the signal, and using a calibrated version so as to generate a corrected calibrated detector signal for each of a plurality of radiation sensitive detectors;
using the corrected calibrated detector signals to generate volumetric data indicative of the object;
displaying a human readable image indicative of the volumetric data.

2. The method of claim I wherein using a calibrated version includes interpolating the calibrated version of the signal generated by the second radiation sensitive detector and a calibrated version of a signal generated by a third radiation sensitive detector during the computed tomography scan to generate an interpolated signal, wherein evaluating a signal generated by the first radiation sensitive detector includes detecting a decrease in the signal generated by the first radiation sensitive detector between views acquired during the computed tomography scan and comparing a value of the signal generated by the first radiation sensitive detector to a threshold value, wherein evaluating a calibrated version of the signal includes comparing a value of the calibrated version of the signal and a value of the interpolated signal, and wherein using a calibrated version includes setting the value of the corrected calibrated first detector signal equal to the value of the interpolated signal at a plurality of the acquired views.

3. The method of claim 2 including repeating the step of comparing a calibrated version using signals from a plurality of views acquired during the computed tomography scan.

4. The method of claim 1 wherein evaluating a signal generated by the first radiation sensitive detector includes evaluating an amplitude of the signal.

5. The method of claim 4 wherein evaluating an amplitude includes comparing the amplitude to a threshold value.

6. The method of claim 4 wherein evaluating a signal generated by the first radiation sensitive detector includes evaluating a change in the amplitude of the signal.

7. The method of claim 4 including using a calibrated version of the signal generated by a third radiation sensitive detector during the computed tomography scan of the object to generate the corrected calibrated first detector signal.

8. The method of claim 7 including interpolating the calibrated versions of the signals generated by the second and third radiation sensitive detectors to generate an interpolated signal and using the interpolated signal to generate the corrected calibrated first detector signal.

9. The method of claim 8 including setting the first corrected calibrated radiation sensitive detector signal equal to the interpolated signal.

10. The method of claim 8 wherein evaluating a calibrated version of the signal generated by the first radiation sensitive detector includes evaluating an amplitude of the calibrated version of the signal generated by the first radiation sensitive detector.

11. The method of claim 10 wherein evaluating an amplitude of the calibrated version of the signal generated by the first radiation sensitive detector includes comparing the amplitude of the calibrated version of the signal generated by the first radiation sensitive detector to an amplitude of the interpolated signal.

12. The method of claim 11 including repeating the step of comparing a calibrated version using temporally corresponding signals from a plurality of views acquired during the computed tomography scan.

13. The method of claim 1 wherein the detector calibration includes a calibration for detector offset.

14. An apparatus comprising:
first, second, and third detector elements which generate respective time varying first, second, and third detector signals indicative of radiation detected during a computed tomography scan of an object;
a detector calibrator which receives the first, second and third detector signals and generates respective time varying calibrated first, second, and third detector signals;
a corrector which corrects temporal portions of the first detector signal, wherein the temporal portions are identified based on a characteristic of the first detector signal and a characteristic of the calibrated first detector signal, and wherein temporally corresponding portions of the second and third calibrated detector signals are used to correct the identified portions of the first detector signal.

15. The apparatus of claim 14 including a signal interpolator which interpolates the calibrated second and third detector signals to generate an interpolated signal and wherein the corrector uses the interpolated signal to correct the identified portions.

16. The apparatus of claim 14 wherein the characteristic of the first detector signal includes a rate of change.

17. The apparatus of claim 14 wherein the characteristic of the first detector signal includes an amplitude.

18. The apparatus of claim 15 wherein the characteristic of the calibrated first detector signal includes an amplitude of the calibrated first detector signal relative to an amplitude of the interpolated signal.

19. The apparatus of claim 14 wherein the first detector element includes a photodiode and the characteristic of the first detector signal and the characteristic of the first calibrated detector signal include characteristics indicative of an error resulting from an impurity in the photodiode.

20. The apparatus of claim 14 wherein the detector calibrator performs calibrations for detector gain and offset.

21. A computer readable storage medium containing instructions which, when executed by a computer processor, cause the processor to carry out a method comprising:
evaluating a signal generated by a first radiation sensitive detector element in the course of a computed tomography scan of an object to determine whether the signal is suspected of containing an error resulting from a characteristic of the first detector element;
evaluating a calibrated version of the signal generated by the first detector element in relation to a calibrated version of a temporally corresponding signal generated by a second radiation sensitive detector element in the course of the scan to determine whether the calibrated version of the signal generated by the first detector element is suspected of containing the error;
if both the signal generated by the first detector element and the calibrated version of the signal generated by the first detector element are suspected of containing the error, using the calibrated version of the signal generated by the second detector element to correct the calibrated version of the signal generated by the first detector element.

22. The computer readable storage medium of claim 23 wherein the error is a delayed signal component which follows a change in the intensity of the radiation received by the first detector element.

23. The computer readable storage medium of claim 21 wherein the method includes interpolating the calibrated version of the signal generated by the second detector element and a temporally corresponding calibrated version of a signal generated by a third radiation sensitive detector element in the course of the scan to generate an interpolated signal, and wherein evaluating a calibrated version includes comparing the calibrated version of the signal generated by the first detector element to the interpolated signal.

24. The computer readable storage medium of claim 23 wherein the first, second, and third detector elements generate signals indicative of radiation detected at a plurality of views during the scan and wherein the method further comprises repeating the step of comparing the calibrated version for signals generated at each of a plurality of views.

25. The computer readable storage medium of claim 21 wherein evaluating a signal generated by a first radiation sensitive detector includes determining an amplitude of and a change in the amplitude of the signal generated by the first detector.

26. The computer readable storage medium of claim 21 wherein the method includes identifying and adaptively correcting the suspect detector signals based on information acquired during the scan.
